(19) United States
(12) Patent Application Publication
(10) Pub. No.: US 2018/0109649 A1
(43) Pub. Date: Apr. 19, 2018

(54) Suggesting Communication Options Using Personal Digital Assistants

(71) Applicant: Microsoft Technology Licensing, LLC, Redmond, WA (US)

(72) Inventor: Dhirendra Kumar Bhupati, Redmond, WA (US)

(21) Appl. No.: 15/293,746

(22) Filed: Oct. 14, 2016

(51) Int. Cl. H04L 29/08

(52) U.S. Cl. CPC H04L 67/327; H04L 67/22

(57) ABSTRACT

A technique is described herein for assisting a first user in communicating with a second user. The first user is associated with a first personal digital assistant (PDA1) component, while the second user is associated with a second personal digital assistant (PDA2) component. When the first user attempts to communicate with the second user, the PDA2 component cooperates with the PDA1 component to provide at least one PDA2-suggested communication option to the PDA1 component. The PDA1 component may provide the PDA2-suggested communication option(s) to the first user via a contact card associated with the second user. A registration system plays a role in establishing the interaction between the PDA1 component and the PDA2 component when status information pertaining to the second user is sufficiently fresh; otherwise, the registration service can provide one or more default registration-service-specified communication options to the first user.

### BACKGROUND

In current practice, a first user can choose from among several communication options to interact with a second user. For example, the first user can set up a telephone call, video conferencing session, etc. Or the first user may send an instant message (using an instant messaging application), a text, an Email, etc. to the second user. On any particular occasion, the first user may choose a communication option based on various ad hoc considerations. For example, the first user may choose whatever communication option that he or she most commonly uses to interact with the second user. Or the first user may choose a communication option based on the perceived preference of the second user.

An attempt by the first user to communicate with the second user fails when the second user is unable or unwilling to interact with the first user via the chosen communication option, at the current time. For instance, the first user may attempt to establish a telephone call with the second user when the second user is unable to receive it, e.g., because the user is occupied with a task that precludes handling the telephone call.

An individual application (such as an Email application) sometimes provides presence information which alerts the first user whether the second user is currently active with respect to that particular application. But this presence information is narrow in scope and unreliable. For example, the second user may be signed onto a particular application, but may be otherwise unavailable to interact with the first user.

### SUMMARY

A computer-implemented technique is described herein for assisting a first user in communicating with a second user. The first user is associated with a first personal digital assistant (PDA1) component, while the second user is associated with a second personal digital assistant (PDA2) component. In one implementation, when the first user attempts to communicate with the second user, the PDA2 component cooperates with the PDA1 component to provide at least one PDA2-suggested communication option to the first user. The PDA2 component selects the PDA2-suggested communication option(s) based on consideration of the current context of the second user.

According to another illustrative aspect, the first user triggers the interaction between the PDA1 component and the PDA2 component by activating a digital contact card associated with the second user. Further, the PDA1 component can display the PDA2-suggested communication option(s) via the digital contact card.

According to another illustrative aspect, a registration system provides initial setup information to the PDA1 component, for use by the PDA1 component in contacting the PDA2 component. But if the registration system determines that the current status of the second user has not been recently updated by the PDA2 component (with respect to an environment-specific update rate), the registration system can send at least one registration-service-specified communication option to the PDA1 component. The PDA1 component can immediately provide the registration-service-specified communication option(s) to the first user, without receiving the PDA2-suggested communication option(s) from the PDA2 component.

The above technique can be manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows a system for assisting a first user in communicating with a second user. The system leverages a first personal digital assistant (PDA1) component associated with the first user and a second personal digital assistant (PDA2) component associated with the second user.

FIG. 2 shows computing equipment for use in implementing the system of FIG. 1.

FIG. 3 shows a signal diagram that explains one manner by which a registration system (which is a component of the system of FIG. 1) can update status information, describing the current status of the first user and the second user.

FIG. 4 is a signal diagram that explains one manner by which the system of FIG. 1 can provide one or more PDA2-suggested communication options to the first user.

FIG. 5 is a signal diagram that explains one manner by which the system of FIG. 1 can provide one or more registration-service-specified communication options to the first user, upon determining, by the registration system, that the status information pertaining to the second user is not sufficiently up to date.

FIG. 6 shows a digital contact card associated with a second user, prior to the receipt of PDA2-suggested communication options.

FIG. 7 shows a digital contact card associated with the second user, showing one PDA2-suggested communication option.

FIG. 8 shows another digital contact card showing another PDA2-suggested communication option.

FIG. 9 shows one implementation of a suggestion component that provides PDA2-suggested communication option(s).

FIG. 10 shows a variation of the system of FIG. 1, which accommodates the scenario in which the first user attempts to communicate with two or more other users.

FIG. 11 shows digital contact card information that can be presented by the system of FIG. 10.

FIG. 12 is a flowchart that describes one manner by which the registration system can update status information.

FIG. 13 is a flowchart that describes one manner by which the registration system can handle status inquiries from any PDA component.

FIG. 14 is a flowchart that describes one manner of operation of the system of FIG. 1, from the perspective of the PDA1 component.

FIG. 15 is a flowchart that describes one manner of operation of the system of FIG. 1, from the perspective of the PDA2 component.

FIG. 16 shows a representative PDA component for use in conjunction with the system of FIG. 1.

FIG. 17 shows a language understanding component for use in the PDA component of FIG. 16.

FIG. 18 shows illustrative computing functionality that can be used to implement any aspect of the features shown in the foregoing drawings.

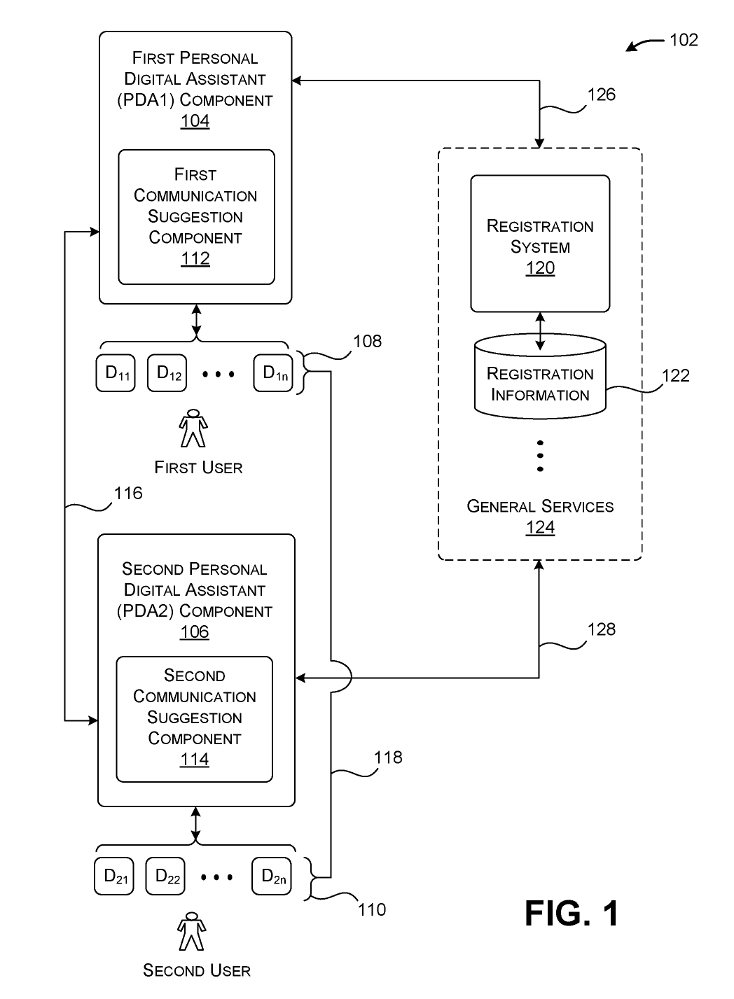

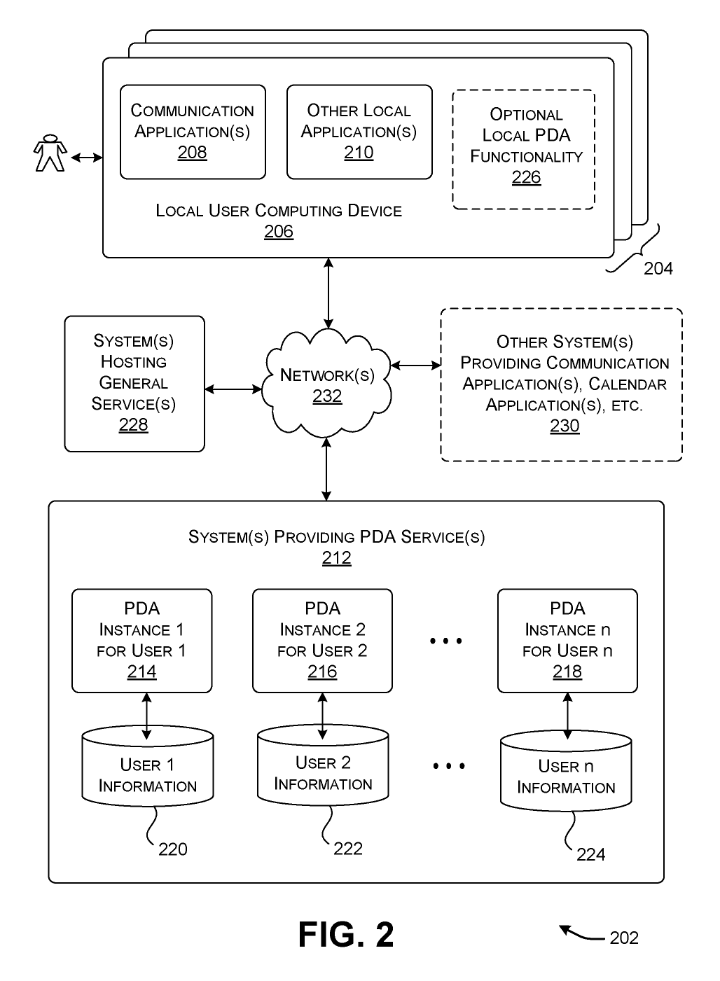

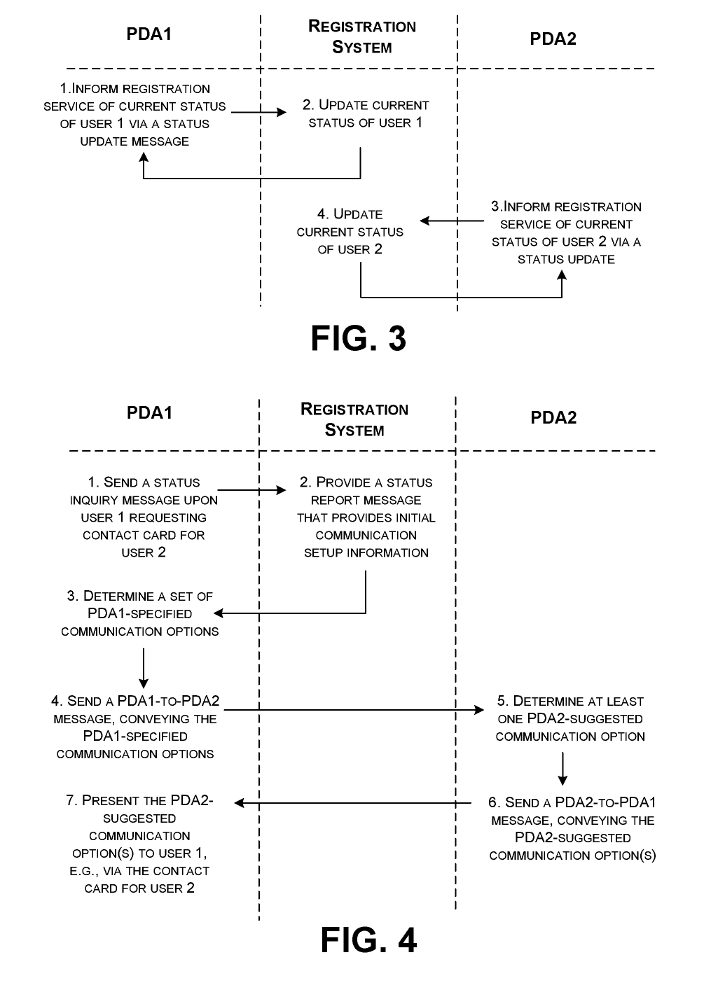

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes a computer-implemented system for assisting a first user in communicating with a second user. Section B sets forth illustrative methods which explain the operation of the system of Section A. Section C provides an example of a personal digital assistant (PDA) component that can be used in conjunction with the system of FIG. 1. And Section D describes illustrative computing functionality that can be used to implement any aspect of the features described in Sections A-C.

As a preliminary matter, some of the figures describe concepts in the context of one or more structural components, also referred to as functionality, modules, features, elements, etc. In one implementation, the various components shown in the figures can be implemented by software running on computer equipment, or other logic hardware (e.g., FPGAs), etc., or any combination thereof. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. Section D provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). In one implementation, the blocks shown in the flowcharts can be implemented by software running on computer equipment, or other logic hardware (e.g., FPGAs), etc., or any combination thereof.

As to terminology, the phrase “configured to” encompasses various physical and tangible mechanisms for performing an identified operation. The mechanisms can be configured to perform an operation using, for instance, software running on computer equipment, or other logic hardware (e.g., FPGAs), etc., or any combination thereof.

The term “logic” encompasses various physical and tangible mechanisms for performing a task. For instance, each operation illustrated in the flowcharts corresponds to a logic component for performing that operation. An operation can be performed using, for instance, software running on computer equipment, or other logic hardware (e.g., FPGAs), etc., or any combination thereof. When implemented by computing equipment, a logic component represents an electrical component that is a physical part of the computing system, in whatever manner implemented.

Any of the storage resources described herein, or any combination of the storage resources, may be regarded as a computer-readable medium. In many cases, a computer-readable medium represents some form of physical and tangible entity. The term computer-readable medium also encompasses propagated signals, e.g., transmitted or received via a physical conduit and/or air or other wireless medium, etc. However, the specific terms “computer-readable storage medium” and “computer-readable storage medium device” expressly exclude propagated signals per se, while including all other forms of computer-readable media.

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Finally, the terms “exemplary” or “illustrative” refer to one implementation among potentially many implementations.

A. Illustrative System

FIG. 1 shows a system 102 for assisting a first user in communicating with a second user, and vice versa. The system 102 leverages a first personal digital assistant (PDA1) component 104 associated with the first user and a second personal digital assistant (PDA2) 106 component associated with the second user. A PDA component refers to technology that assists a user in performing various tasks, such as scheduling a meeting, purchasing an airline ticket, performing a search, etc. A PDA is “personal” insofar as it provides customized service to a particular user. It provides personalized service, in part, based on knowledge gained through past interactions with the user, and through privileged access to other applications associated with the user (such as a calendar application). In one implementation, each PDA component corresponds to an instance of the CORTANA personal digital assistant service, provided by MICROSOFT CORPORATION of Redmond, Wash., which has been modified and supplemented in the manner described below to provide new cross-PDA functions.

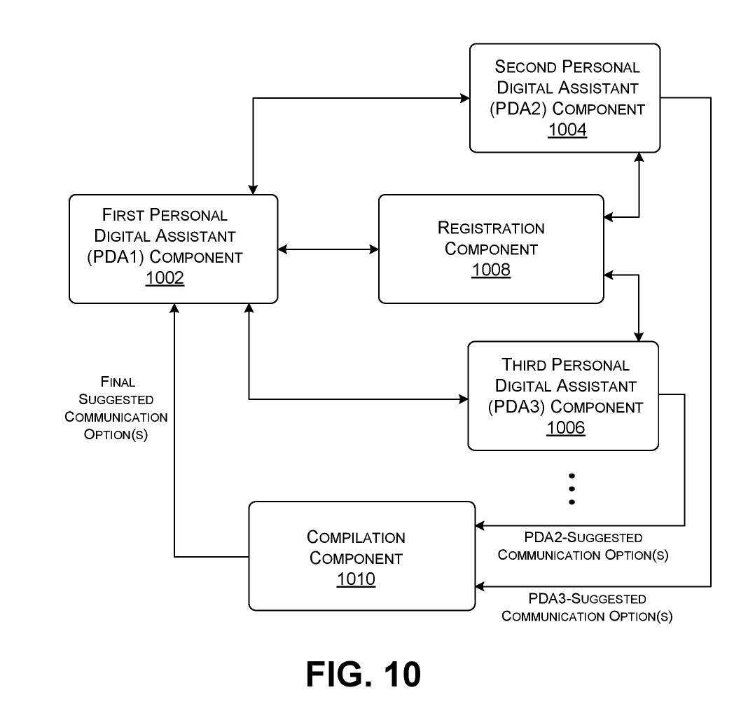

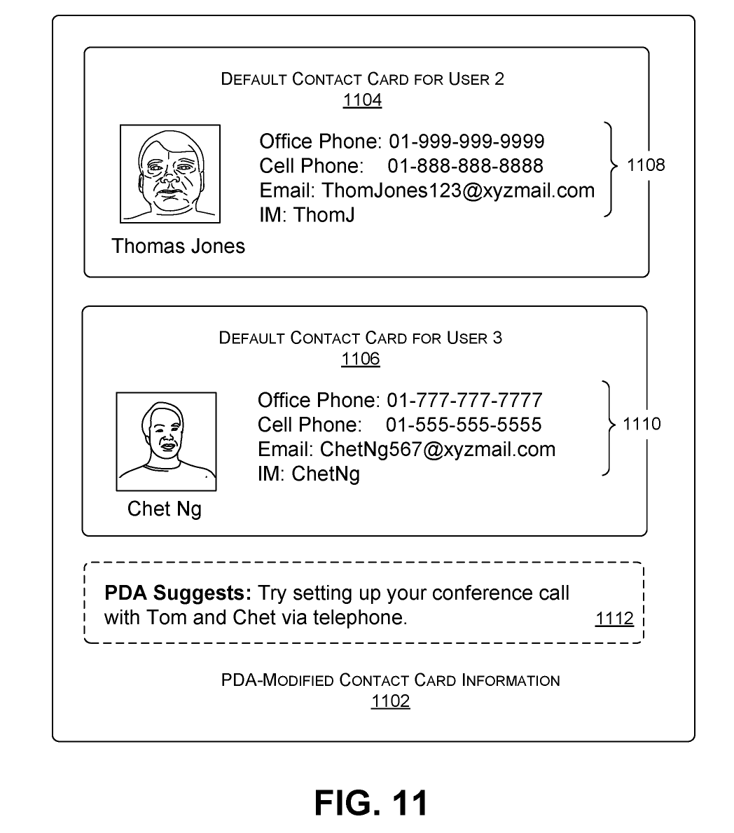

While the system 102 shows two PDA components (104, 106), the system 102 can include any number of PDA components which cooperatively work to establish a communication session among three or more people. FIGS. 10 and 11 set forth such an implementation. However, to simplify and facilitate explanation, it will be initially assumed that the system 102 provides guidance to the first user in communicating with one other user (i.e., the second user).

The PDA1 component 104 provides its services to the first user, who interacts with the PDA1 component 104, using one or more user computing devices 108. Likewise, the PDA2 component 106 provides its services to the second user, who interacts with the PDA2 component 106 using one or more user computing devices 110.

The system 102 is described below in the illustrative context in which the first user initiates communication with the second user. But the system 102 also allows the second user to initiate communication with the first user. As used herein, “communication” between the first user and the second user may entail establishing a communication session over a communication channel, whereby the first and second users exchange messages with each other. In other cases, “communication” can entail the transmission of at least one message to the second user via a communication channel, e.g., without necessarily receiving a reply from the second user.

The PDA1 component 104 includes a first communication suggestion component 112, while the PDA2 component 106 includes a second communication suggestion component 114. The first communication suggestion component 112 cooperates with the second communication suggestion component 114 via a communication channel 116 to assist the first user in communicating with the second user. More specifically, the second communication suggestion component 114 generates one or more PDA2-suggested communication options for consideration by the first user. The first user may select one of these options, thereby establishing communication between the first user and the second user. FIG. 1 generically shows a channel 118 which represents communication between any user computing device associated with the first user and any user computing device associated with the second user.

In some implementations, a registration system 120 plays a role in setting up the interaction between the PDA1 component 104 and the PDA2 component 106. The registration system 120 maintains a data store 122 of status information. The status information describes the current status of the first user and the second user. More specifically, the current status of the first user reflects the first user's current situation within an environment, e.g., as described by the first user's location in the environment, the first user's access to communication resources at the present time, the first user's proximity to other users, and so on

In operation, the PDA1 component 104 sends a status update message to the registration system 120, which provides update status information regarding the current status of the first user. The PDA1 component 104 can send the status update message on a periodic basis (e.g., every five minutes) and/or an event-driven basis (e.g., when the status of the first user is determined to have changed). Likewise, the PDA2 component 106 sends a status update message to the registration system 120 on a periodic and/or event-driven basis, which provides update status information regarding the second user.

The PDA1 component 104 contacts the registration system 120 when the first user evinces an intent to communicate with the second user. In response, the registration system 120 determines whether the status information regarding the second user is sufficiently up to date, with respect to any environment-specific update criterion. For example, if the registration system 120 expects to receive an update every hour, the registration system 120 will determine if the last-provided status update message from the PDA2 component 106 is no older than one hour.

When the registration system 120 determines that the status information for the second user is sufficiently fresh, it sends initial communication setup information to the PDA1 component 104. The PDA1 component 104 uses the initial communication setup information to establish an interaction session with the PDA2 component 106. But when the registration system 120 determines that the status information for the second user is not sufficiently fresh, it will send one or more registration-service-specified communication options. The PDA1 component 104 immediately presents the registration-service-specified communication options to the first user, instead of interacting with the PDA2 component 106 to obtain one or more PDA2-suggested communication options.

In one implementation, the PDA1 component 104 determines that the user intends to communicate with the second user when the first user opens a digital contact card associated with the second user. Further, the PDA1 component 104 can convey the PDA2-suggested communication options to the first user via the digital contact card that has been opened.

Further note that the registration system 120 may correspond to part of a more encompassing set of general services 124 available to the PDA1 component 104 and the PDA2 component 106. For instance, the general services 124 can include a repository of digital contact cards associated with different users. Any PDA component can retrieve a digital contact card from the repository for presentation to a user. In general, FIG. 1 shows that the PDA1 component 104 interacts with the general services 124 via a first communication channel 126, and the PDA2 component 106 interacts with the general services 124 via a second communication channel 128.

Finally, the system 102 can include a configuration service that runs on each local computing device and/or on a remote computing system. The configuration service allows each user to configure the system 102 to operate in a customized manner, with respect to a service provided to each individual user. For example, the configuration service allows each user to opt in to and/or opt out of the suggestion-generating capability of the system 102. Further, when a user opts in to the suggestion-generating capability, the configuration service optionally allows each user to specify a custom set of communication participants for which the capability will be applied. This provision ensures that the status of the user is released to only those users to whom the user selects.

In summary, a PDA component traditionally serves the role of interacting with only a single user. The system 102 of FIG. 1 provides new mechanisms which use a PDA component to also interact with at least one other PDA component, on behalf of a communication setup task initiated by the first user.

FIG. 2 shows computing equipment 202 for use in implementing the system 102 of FIG. 1. The computing equipment 202 includes a plurality of user computing devices 204, including a representative user computing device 206.

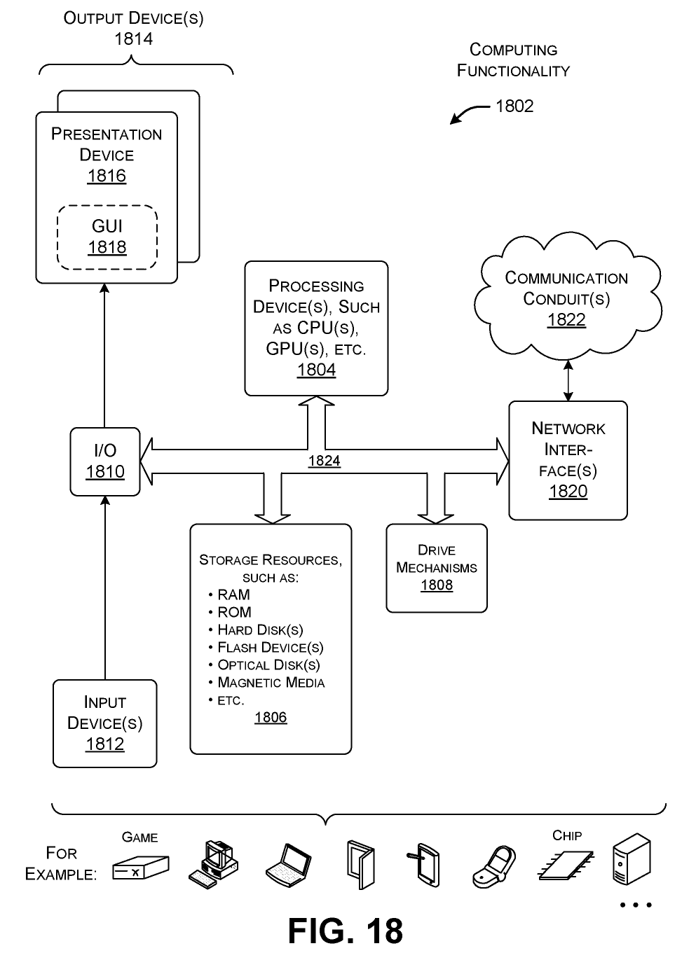

The representative user computing device 206 may correspond to any of a desktop personal computing device, a laptop computing device, a set-top box device, a game console, a smartphone or other type of handheld computing device, a wearable computing device, and so on. The representative user computing device 206 can host any local communication applications 208 and any other local applications 210 (e.g., a calendar application). Although not shown in FIG. 2 (but is shown in FIG. 18), the user computing device 206 can also include input devices, output devices, a network interface, etc.

In some implementations, at least one system 212 may host a service that provides a plurality of PDA instances (214, 216, . . . , 218). The PDA instances (214, 216, . . . , 218) are associated with respective users, and provide services to those users. Further, the PDA instances (214, 216, . . . , 218) maintain information regarding the users in respective data stores (220, 222, . . . , 224). In one implementation, the PDA instances (214, 216, . . . , 218) refer to instances of common PDA resources provided by the system(s) 212, configured to provide service to respective users.

In one case, a single system, administered by a single entity, provides the plurality of PDA instances (214, 216, . . . , 218). In another case, two or more distinct systems, administered by the same entity or different respective entities, provide the plurality of PDA instances (214, 216, . . . , 218). For example, a first service provider can provide a first set of PDA instances, while a second provider can provide a second set of PDA instances. The two sets of PDA instances can operate using a same computing platform or different respective computing platforms.

In the latter case (in which PDA instances communicate across different computing platforms), the system 102 of FIG. 1 performs any kind of handshaking between different computing platforms when a PDA component from a first computing platform seeks to interact with a PDA component from a second computing platform. The handshaking can entail converting a message from a source computing platform to a format expected by the target computing platform to which it is being sent. The handshaking can also entail providing appropriate security credentials that allow a PDA component associated with one computing platform to interact with a PDA component associated with another computing platform.

Alternatively, or in addition, each individual user computing device can host at least part of the resources associated with a PDA component. For example, assume that the local user computing device 206 is associated with the first user shown in FIG. 1. The local user computing device 206 can provide local PDA functionality 226 which implements at least part of the PDA1 component 106.

More generally, different providers can provide different kinds of PDA components. Section C of this explanation (below) provides a description of one representative type of PDA component that can be used in conjunction with the system 102 of FIG. 1.

The computing equipment 202 can also provide one or more systems 228 for implementing the general services 124, e.g., including the registration system 120 and the data store 122. The system(s) 228 can also provide a service that provides a repository of digital contact cards for consumption by the PDA instances (214, 216, . . . , 218). The computing equipment 202 can also provide one or more other systems 230 for hosting other applications, such as various communication applications, a calendar application, etc.

One or more computer networks 232 communicatively couple the above-described components together. The computer network(s) can correspond to a wide a area network (e.g., the Internet), a local area network, one or more point-to-point communication links, etc.

FIG. 3 shows a signal diagram that explains one manner by which the registration system 120 of FIG. 1 can update status information, describing the current status of the first user and the second user. In operation (1), the PDA1 component 104 sends a status update message to the registration system 120, e.g., on a periodic basis and/or on an event-driven basis. The status update message includes status update information which describes the current status of the first user. In operation (2), the registration system 120 stores the status update information in the data store 122.

Similarly, in operation (3), the PDA2 component 106 sends a status update message to the registration system 120, e.g., on a periodic basis and/or an event-driven basis. The status update message includes status update information which describes the current status of the second user. In operation (4), the registration system 120 stores the status update information in the data store 122.

FIG. 4 is a signal diagram that explains one manner by which the system 102 of FIG. 1 can provide one or more PDA2-suggested communication options to the first user. In operation (1), the PDA1 component 104 sends a status inquiry message to the registration service. In one case, the PDA1 component 104 performs this action when the first user opens up a digital contact card associated with the second user. The PDA1 component 104 can obtain the digital contact card from any source, such as a local source (associated with the user computing device with which the first user is interacting), and/or a remote computing device. In still other cases, the PDA1 component 104 itself may provide the digital contact card.

In operation (2), the registration system 120 determines whether the data store 122 stores status information regarding the second user that is sufficiently up to date, as assessed with respect to any environment-specific updating interval. In the case of FIG. 4, assume that the registration system 120 determines that the status information is, in fact, up to date. The registration system 120 then sends a status report message to the PDA1 component 104. The status report message PDA1 can include various information, such as an indication of the location of the second user and an endpoint address for use in interacting with the PDA2 component 106.

In operation (3), the PDA1 component 104, upon receipt of the status report message, can optionally determine a PDA1-specified set of communication options which the first user can use to communicate with the second user, from the perspective of the PDA1 component 104. For example, assume that the digital contact card that the first user retrieves (associated with the second user) lists a set of default communication options. The PDA1 component 104 can identify a subset of the default communication options which the first user is capable of using to communicate with the second user. That is, assume that the default digital contact card lists options A, B, C, D, E, and F, but that the first user only supports options A, D, E, and F. In that case, the PDA1-specified communications would include options A, D, E, and F. In operation (4), the PDA1 component 104 sends a PDA1-to-PDA2 message to the PDA2 component 106. The PDA1-to-PDA2 message conveys the PDA1-specified communication options, if, in fact, these options were determined in operation (3).

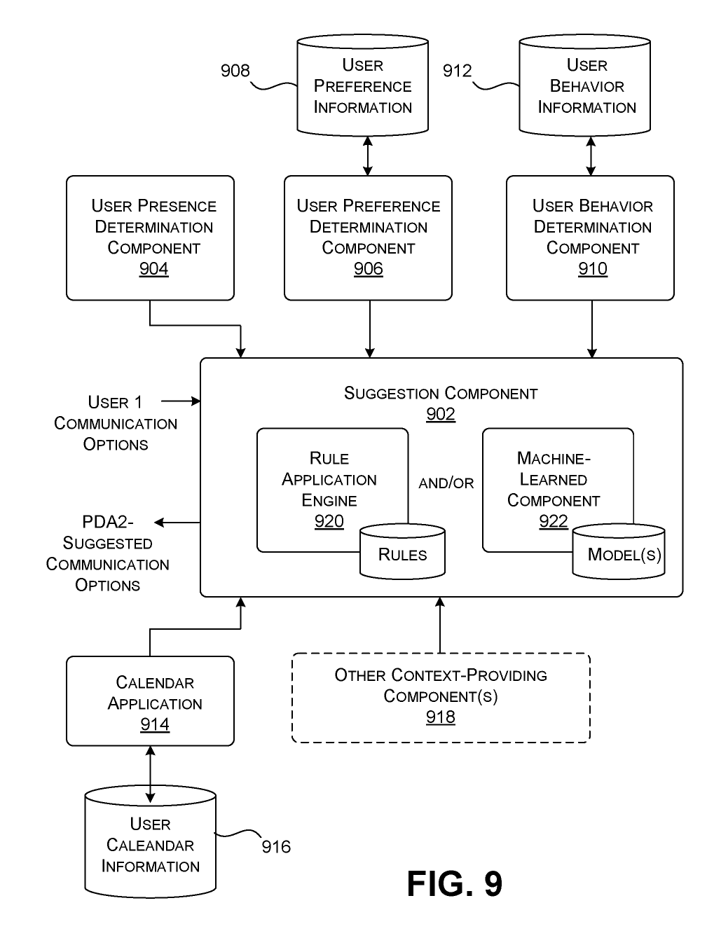

In operation (5), the PDA2 component 106, upon receipt of the PDA1-to-PDA2 message, determines at least one PDA2-suggested communication option based on the current status of the user. FIG. 9 and the accompanying description will explain one way in which the PDA2 component 106 performs this task. Suffice it to say at this point that the PDA2 component 106 chooses one or more PDA2-suggested communication options that are most suitable for the second user, in view of the current circumstance of the second user. For example, the PDA2 component 106 may omit a video conferencing option when it determines that the user is currently driving his or her car. In operation (6), the PDA2 component 106 sends a PDA2-to-PDA1 message to the PDA1 component 104, which conveys the PDA2-suggested communication option(s).

In operation (7), the PDA1 component 104 presents the PDA2-suggested communication option(s) to the first user. The PDA1 component 104 can display the PDA2-suggested communication option(s) as part of the digital contact card (associated with the second user) which the first user has activated.

In response to receiving the PDA2-suggested communication option(s), the first user may opt to invoke one of these options to communicate with the second user. For example, if the PDA2-suggested communication option specifies an Email communication channel, the first user may send an Email message to the second user.

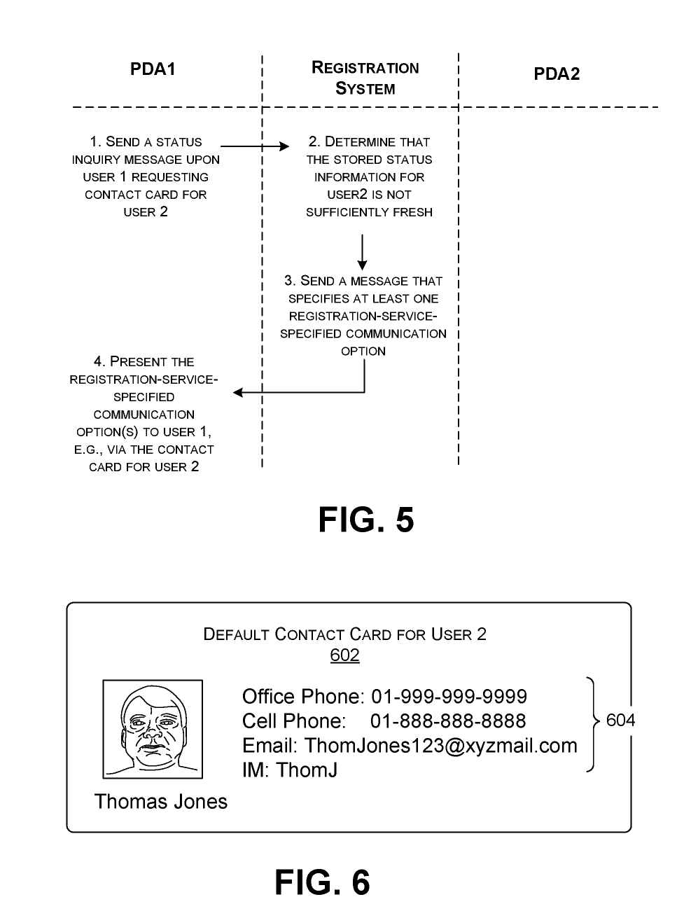

FIG. 5 is a signal diagram that explains one manner by which the system 102 of FIG. 1 can provide one or more registration-service-specified communication options to the first user, upon determining, by the registration system 120, that the status information pertaining to the second user is not sufficiently up to date. In operation (1), the PDA1 component 104 sends a status inquiry message to the registration system 120, e.g., in response to the first user opening a digital contact card associated with the second user. In operation (2), the registration system 120 determines whether the status information associated with the second user is sufficiently up to date, e.g., again with respect to any environment-specific freshness criterion. In this case, assume that the status information is stale. For example, the second user may be traveling on an airplane, which has prevented the second user from interacting with his or her PDA2 component 106 for several hours, which, in turn, prevents the PDA2 component 106 from reporting the current whereabouts of the second user for several hours.

In response to this determination, the registration system 120 can generate one or more registration-service-suggested communication options. These communication options are default options that account for the fact that the status information for the second user is not sufficiently up to date; but these communication options otherwise fail to take account for the actual current status of the second user (which is unknown at this time). For example, the registration system 120 can suggest that the first user contact the second user via an Email application, because the availability of the second user cannot be assured for the purpose of handling real-time interaction (e.g., via a phone call or the like). In operation (3), the registration system 120 sends a message to the PDA1 component 104 which conveys the registration-service-suggested communication option(s). In operation (4), the PDA1 component 104 presents the registration-service-suggested communication option(s), e.g., via the digital contact card of the second user.

FIG. 6 shows a default digital contact card 602 associated with a second user, prior to the receipt of PDA2-suggested communication options from the PDA2 component 106. The default digital contact card 602 includes a set of default communication options 604. In one implementation, the second user creates the default digital contact card 602. In that case, the second user manually specifies the entries in the set of default communication options.

In one case, the second user provides the default communication options 604 by manually typing them using an input device. In another case, the second user provides the default communication options 604 by importing them from some other source. In another case, the second user provides the entire default contact card 602 by scanning a hardcopy version of contact card 602 using a scanning device, to create a digital image of the hardcopy version.

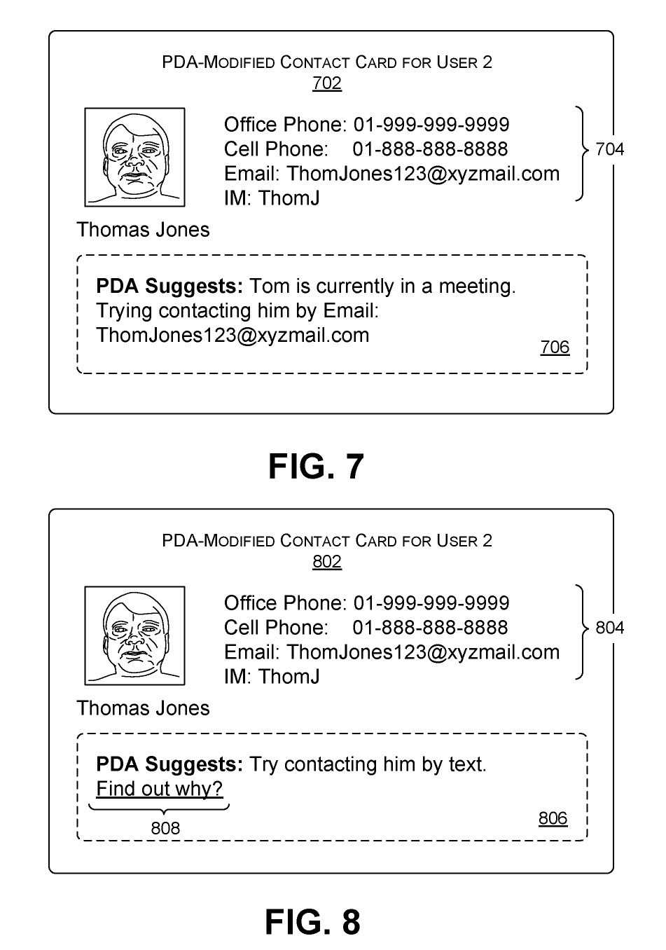

FIG. 7 shows a digital contact card 702 associated with the second user which represents the same digital contact card 602 of FIG. 6, but supplemented to include information provided by the PDA2 component 106. That is, the digital contact card 702 includes the same default communication options 704 shown in FIG. 6. In addition, the digital contact card 702 includes a PDA2-suggested communication option 706. That option 706 invites the first user to contact the second user via an Email application. The option 706 also provides an optional explanation of why this particular suggestion is being made. For example, that explanation informs the first user that the second user is currently in a meeting and therefore cannot receive a telephone call.

FIG. 8 shows another digital contact card 802 that provides the same default communication options 804. The digital contact card 802 also provides another PDA2-suggested communication option 806. The PDA2-suggested communication option 806 in this example invites the first user to send a text to the second user. The PDA2-suggested communication option 806 can also provide a control feature 808; upon activation of the control feature 808 by the first user, the PDA1 component 104 provides the first user with an explanation of why this particular communication option has been given.

FIG. 9 shows one implementation of a suggestion component 902 for use in a PDA component. For example, the suggestion component 902 may correspond to the second communication suggestion component 114 shown in FIG. 1, which is part of the PDA2 component 106. In that context, the suggestion component 902 provides at least one PDA2-suggested communication option to the first PDA1 component 104. The suggestion component 902 generates the PDA2-suggested communication option(s) based on a consideration of the current context of the second user. The suggestion component 902 will be explained below with respect to the above-described scenario (in which the suggestion component 902 corresponds to the second communication suggestion component 114 of FIG. 1).

The suggestion component 902 can collect context information that describes the current context of the second user from various sources, any of which may be part of the PDA2 component 106, or apart therefrom. For instance, a user presence determination component 904 determines the current location and/or status of the second user. The user presence determination component 904 can determine the second user's presence based on any combination of: (a) absolute location information that indicates the current geographic location of the second user; (b) relative location information that indicates that the second user is in the vicinity of some other user or entity; and (c) computer activity information that indicates the manner in which the second user is currently interacting with certain devices, systems, applications, etc.

More specifically, the user presence determination component 904 can determine the absolute location information based on position information provided by any kind of position-determining device carried by, or otherwise associated with, the second user, such as a GPS device integrated into a smartphone carried by the user. The user presence determination component 904 can determine the relative location information based on, for instance, near-field presence information provided by a Near Field Communication (NFC) device carried by, or otherwise associated with, the second user, or based on an NFC device associated with another user with whom the second user comes into close contact. The user presence determination component 904 can determine the computer activity information by receiving log-in status information, input activity information, etc. generated by the computing devices, systems, and applications with which the second user is currently interacting.

The user presence determination component 904 can also provide an indication of the communication resources to which the second user currently has access, and the communication resources to which the second user currently does not have access. The user presence determination component 904 can make this determination in direct fashion, e.g., by determining whether the second user is within a prescribed distance of a wireless communication resource (e.g., a hotspot, radio tower, etc.). The user presence determination component 904 can also infer the availability of communication resources based on the user's current location and/or other factors. For example, the user presence determination component 904 can determine that the user has currently activated the airplane mode of his or her smartphone; based thereon, the presence determination component 904 can determine that the second user currently does not have access to online communication options.

A user preference determination component 906 provides information regarding the previously-specified preferences of the second user, as recorded in a data store 908. For example, the second user may have manually specified that he or she prefers receiving messages via an instant messaging (IM) application or text message, as opposed to an Email application.

A user behavior determination component 910 provides information regarding preferences that can be inferred based on the previous behavior of the user, as provided in a data store 912. For example, the user behavior determination component 910 can store an entry in the data store 912 each time the second user communicates with another user. That entry can identify the communication option that was used to conduct the communication, together with the contextual factors associated with the communication (e.g., the time, date, the location of the second user, the co-presence of other users, etc.). When the suggestion component 902 seeks to generate a suggested communication option, the user behavior determination component 910 can: (a) determine the current contextual situation of the second user; (b) identify the communication options that the second user has previously used in contextual situations matching the current contextual situation; and (c) choose one or more of the most prevalent communication options that have been previously used for those matching contextual situations.

A calendar application 914 provides information regarding the current commitments of the second user (e.g., indicating whether the second user is currently in a meeting, etc.), and/or the upcoming commitments of the second user (e.g., indicating whether the second user is scheduled to attend a meeting in the next 30 minutes, etc.). The calendar application 914 can mine this calendar information from a calendar data store 916.

The suggestion component 902 also takes into consideration the PDA1-specified communication options, provided in the PDA1-to-PDA2 message sent by the PDA1 component 104. For example, the suggestion component 902 will exclude consideration of a particular communication option if the PDA1 component 104 already notifies the suggestion component 902 that it does not support that option.

The above-described sources of context information are cited by way of illustration, not limitation. Other implementations can provide additional sources of context information (e.g., as indicated in FIG. 9 by the generic inclusion of “other context-providing component(s)” 918), and/or can omit one or more sources of context information described above.

The suggestion component 902 maps the context information described above to one or more PDA2-suggested communication operation. In one approach, a rule application engine 920 can apply one or more rules (such as IF-THEN-structured rules) to perform this mapping. For example, one such rule can specify that IF the second user is currently in a meeting, THEN it is appropriate to suggest that the first user contact the second user via an Email application or text message. Another rule can specify that IF the second user is currently traveling by automobile, THEN it is appropriate to suggest that the first user contact the second user via voice mail. Another rule can specify that IF the second user is present in his home, AND the time is after 10:00 pm, THEN it is appropriate to suggest that the first user contact the second user via a video conferencing application. Another rule can specify that IF the second user is in a public place, THEN it is appropriate to suggest that the first user contact the user via an encrypted Email application. Another rule can specify that IF the second user is in the vicinity of his or her spouse (which can be determined by NFC information, etc.), THEN it is appropriate to suggest that the first user contact the second user via an Email application, unless the first user is designated as a priority communication participant (such as a close friend, family member, etc.).

In one approach, the rule application engine 920 can receive rules that are manually specified by the second user, e.g., via a rule-specification user interface presentation (not shown) provided by the rule application engine 920. Alternatively, or in addition, the rule application engine 920 can infer at least some rules based on patterns of conduct identified by the user behavior determination component 910. For example, assume that the user behavior determination component 910 determines that the user never answers his or her phone after 11:00 pm. The rule application engine 920 can generate a rule which formalizes this discovered relationship.

Alternatively, or in addition, the suggestion component 902 can use a machine-learned component 922 to map context information to one or more PDA2-suggested communication options. The machine-learned component 922 uses a machine-learned statistical model produced by a training system (not shown). For example, the training system can collect a corpus of training data which describes the communication options that the second user has chosen in the past, with respect to different contextual factors. The training system can generate the machine-learned statistical model based on this training corpus. The model consists of a set of learned weights that reflect the decisions that the second user has made in the past. In another implementation, the training system can operate on training data that reflects the behavior of a population of users (not just the second user), or a subset of those users who are demographically similar to the second user. The training system can generate any type of machine-learned statistical model, such as a linear classifier, a deep-learning neural network, etc.

FIG. 10 shows a variation of the system 102 of FIG. 1 that accommodates the case in which the first user wishes to communicate with two or more other users, such as a second user and a third user. The first user is associated with a PDA1 component 1002, the second user is associated with a PDA2 component 1004, and the third user is associated with PDA3 component 1006. The system of FIG. 10 also includes a registration system 1008 which performs the same functions as the registration system 120 of FIG. 1.

In operation, the PDA1 component 1002 can interact with the registration system 1008 and the PDA2 component 1004 in the manner described above, which culminates in the PDA2 component 1004 generating a PDA2-suggested set of communication operations. Similarly, the PDA1 component 1002 interacts with the registration system 1008 and the PDA3 component 1006 in the manner described above, which culminates in the PDA3 component 1006 generating at least one PDA3-suggested communication option. A compilation component 1010 then combines the PDA2-suggested communication options and the PDA3-suggested communication options to generate a final set of communication options. The compilation component 1010 forwards the final set of communication options to the PDA1 component 1002, which then presents them to the first user, e.g., via contact card information previously invoked by the first user.

The compilation component 1010 can combine communication suggestions from different PDA components in different ways, such as by intersecting the communication suggestions from different sources to generate a final set of options (if any) that are acceptable to all sources. The compilation component 1010 can represent an element provided by the PDA1 component 1002, and/or an element apart from all PDA components.

In a variation of the system of FIG. 10, the PDA1 component 1002 can receive both the PDA2-suggested communication option(s) and the PDA3-suggested communication option(s), without the culling operation of the compilation component 1010. The first user may then choose to simultaneously interact with the second user and the third user using the same communication option or different respective communication options. For example, the first user may choose a video conferencing option to communicate with both the second user and the third user. Or the first user may choose a video conferencing option to communicate with the first user, and a telephone communication option to communicate with the third user.

In yet another variation, the first user may initially set up a communication session with the second user, and then the first user or the second user may seek to add a third user to the conversation midway through the conversation. When the first user attempts to add the third user, the PDA1 component 1002 can interact with the PDA3 component 1006 in the manner described above. The compilation component 1010 can provide a final set of communication options, if any, which are acceptable from both the standpoint of the second user and the third user. The first user can then opt to add the third user to the same communication session already in progress with the second user, or establish another communication channel with the third user (while maintaining the existing communication channel with the second user), or establish a whole new communication session to interact with the second and third users using a new communication channel.

FIG. 11 shows digital contact card information 1102 that can be presented by the system of FIG. 10. The first user can generate the digital contact card information 1102 by activating the individual contact cards (1104, 1106) of the individuals who will take part in the conversation. The first digital contact card 1104 lists a set of default communication options 1108 associated with a second user, while the second digital contact card 1106 lists a set of default communication options 1110 associated with a third user. The digital contact card information 1102 also provides a final communication option 1112 which takes into consideration the current context of the second user and the third user, as assessed, respectively, by the PDA2 component 1004 and the PDA3 component 1006.

With respect to all implementation, the technique described herein provides helpful guidance to a first user in communicating with one or more other users. The technique increases the probability that the first user will make successful contact with the other user(s). This aspect improves the user experience of all users involved in the communication, and also makes efficient use of computing and communication resources.

In one implementation, the technique also provides the communication suggestions based on interaction between at least two separate PDA components, rather than delegating the decision process to a single decision engine. This characteristic results in accurate communication suggestions because each PDA component has in-depth knowledge of its own associated user. Further, by modifying and integrating with existing PDA resources, the technique eliminates the need to develop custom decision logic.

B. Illustrative Processes

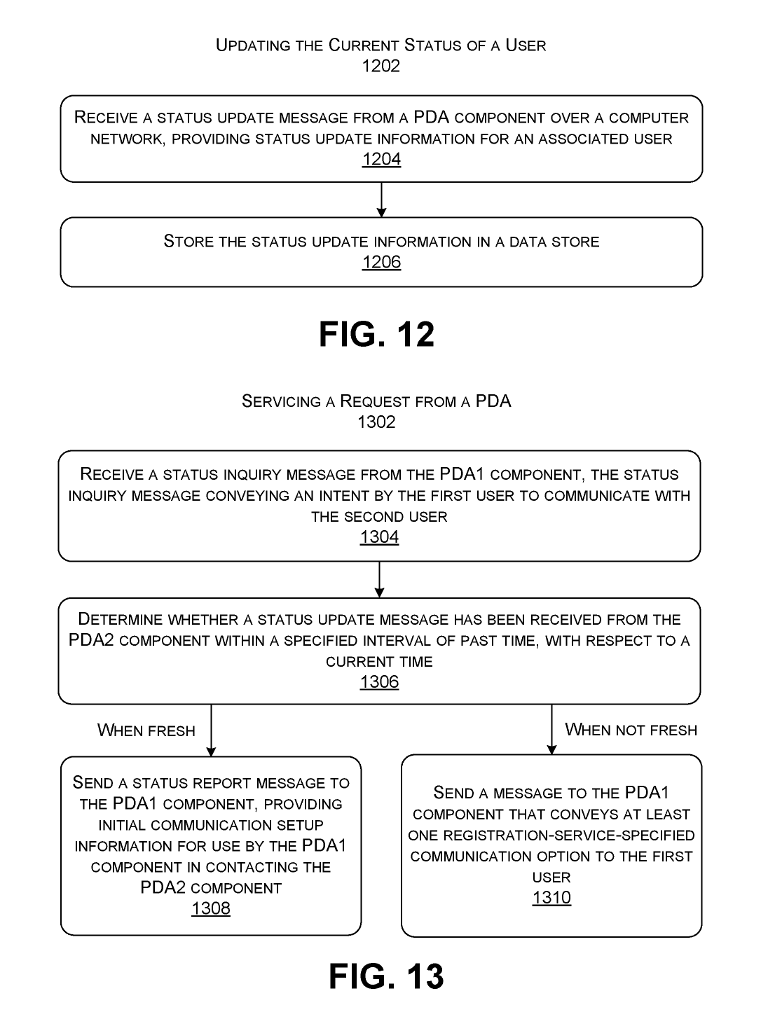

FIGS. 12-15 show processes that explain the operation of the system 102 of Section A in flowchart form. Since the principles underlying the operation of the system 102 have already been described in Section A, certain operations will be addressed in summary fashion in this section. As noted in the prefatory part of the Detailed Description, the flowcharts are expressed as a series of operations performed in a particular order. But the order of these operations is merely representative, and can be varied in any manner.

To begin with, FIG. 12 shows a process 1202 that describes one manner by which the registration system 120 of FIG. 1 can update status information. In block 1204, the registration system 120 receives a status update message from the PDA1 component 104 or the PDA2 component 106 over the computer network 232. The status update message conveys status update information that describes a current status of the first user or the second user, respectively. In block 1206, the registration system 120 stores the status update information in the data store 122.

FIG. 13 shows a process 1302 that describes one manner by which the registration system 120 can handle status inquiries from any PDA component, such as the PDA1 component 104. In block 1304, the registration system 120 receives a status inquiry message from the PDA1 component 104. The status inquiry message conveys an intent by the first user to communicate with the second user. In block 1306, the registration system 120 determines whether a status update message has been received from the PDA2 component 106 within a specified interval of past time, with respect to a current time. In block 1308, if the status update message has been received within the specified interval of past time, the registration system 120 sends a status report message to the PDA1 component 104. In block 1310, if the status update message has not been received within the specified interval of past time, the registration system 120 sends a message to the PDA1 component 104 that conveys at least one registration-service-specified communication option to the first user.

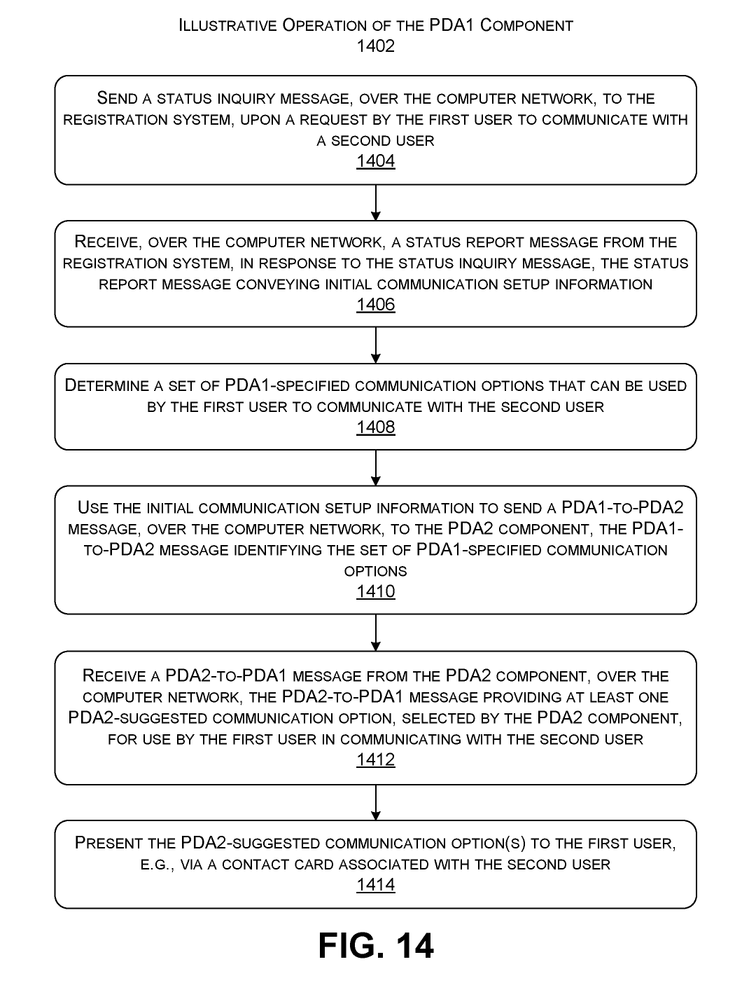

FIG. 14 shows a process 1402 that describes one manner of operation of the system 102 of FIG. 1, from the perspective of the PDA1 component 104. In block 1404, the PDA1 component 104 sends a status inquiry message, over the computer network 232, to the registration system 120, upon a request by the first user to communicate with the second user. In block 1406, the PDA1 component 104 receives, over the computer network 232, a status report message from the registration system 120, in response to the status inquiry message. The status report message conveys initial communication setup information. In block 1408, the PDA1 component 104 optionally determines a set of PDA1-specified communication options that can be used to communicate with the second user. In block 1410, the PDA1 component 104 uses the initial communication setup information to send a PDA1-to-PDA2 message, over the computer network 232, to the PDA2 component 106 associated with the second user. The PDA1-to-PDA2 message optionally identifies the set of PDA1-specified communication options, if provided in block 1408.

In block 1412, the PDA1 component 104 receives a PDA2-to-PDA1 message from the PDA2 component 106, over the computer network 232. The PDA2-to-PDA1 message provides at least one PDA2-suggested communication option, selected by the PDA2 component 106, for use in communicating with the second user. The PDA2 component 106 generates the PDA2-suggested communication option(s) based on consideration of a current context of the second user. In block 1414, the PDA1 component 104 presents the PDA2-suggested communication option(s) to the first user, e.g., via a contact card associated with the second user. The system 102 then carries out communication between a user computing device associated with the first user and a user computing device associated with the second user, upon the first user invoking a PDA2-suggested communication option.

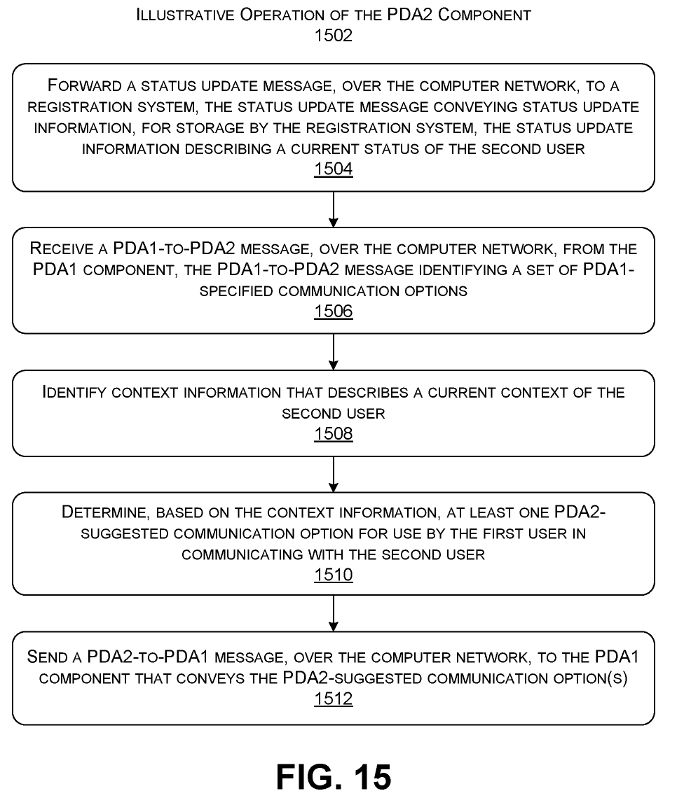

FIG. 15 shows a process 1502 that describes one manner of operation of the system 102 of FIG. 1, from the perspective of the PDA2 component 106. In block 1504, the PDA2 component 106 forwards a status update message, over the computer network 232, to the registration system 120. The status update message conveys status update information, for storage by the registration system 120, the status update information describing a current status of the second user. In block 1506, the PDA2 component 106 receives a PDA1-to-PDA2 message, over the computer network 232, from the PDA1 component 104. The PDA1-to-PDA2 message identifies a set of PDA1-specified communication options. That is, the set of PDA1-specified communication options describes, from a perspective of the PDA1 component 104, viable modes for communicating with the second user. In block 1508, the PDA2 component 106 identifies context information that describes a current context of the second user. In block 1510, the PDA2 component 106 determines, based on the context information, at least one PDA2-suggested communication option for use by the first user in communicating with the second user. In block 1512, the PDA2 component 106 sends a PDA2-to-PDA1 message, over the computer network 232, to the PDA1 component 104 that conveys the PDA2-suggested communication option(s). The method then carries out a communication between a user computing device associated with the first user and a user computing device associated with the second user, upon the first user invoking a PDA2-suggested communication option.

C. Representative Personal Digital Assistant Component

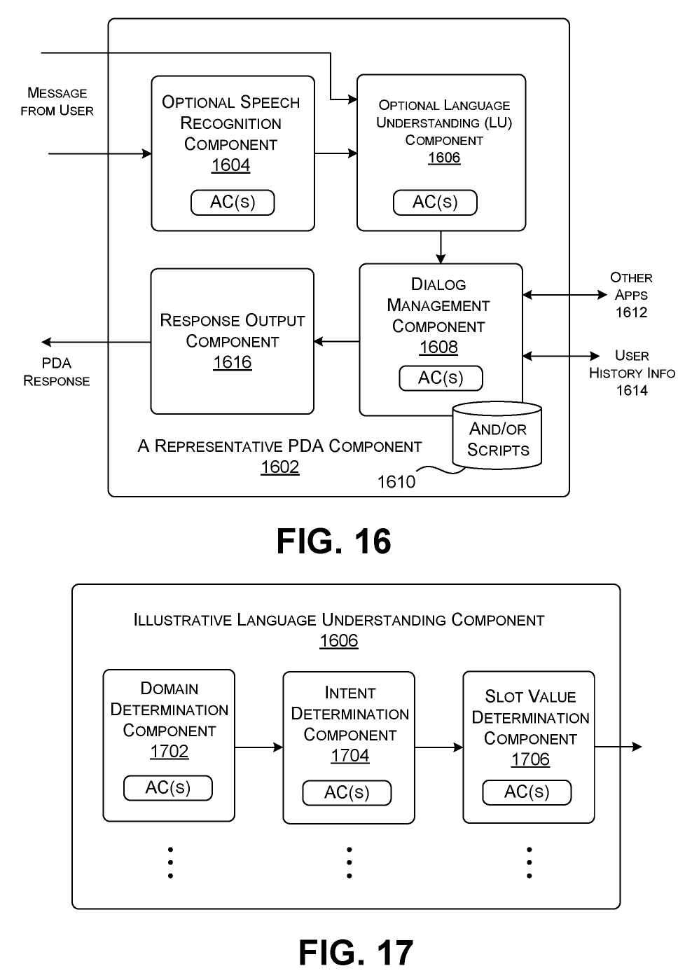

FIG. 16 shows one implementation of a representative personal digital assistant (PDA) component 1602 that can used in the system 102 of FIG. 1. At the outset, however, it is pointed out that the system 102 is specifically designed to interact with a wide variety of PDA components of different types; the particular PDA component shown in FIG. 16 is presented here in the spirit of illustration, not limitation. Further note that the PDA component 1602 shown in FIG. 16 incorporates the functionality shown in FIG. 9, but that functionality is omitted from FIG. 16 to facilitate explanation.

In one implementation, the PDA component 1602 includes four principal parts. As a first part, an optional speech recognition component 1604 receives an input signal from one or more audio input devices (not shown). In some cases, for instance, that input signal expresses a user's utterance as an audio waveform signal, captured by one or more microphones. The speech recognition component 1604 converts the input signal into recognized speech information. The speech recognition component 1604 can use any analysis component(s) (labeled in FIG. 16 as AC(s)) to perform this task, such as a deep-learning neural network of any type.

In an alternative case, the PDA component 1602 receives the user's messages in text form, which, for instance, the user may type into an input interface. In this case, the PDA component 1602 omits use of the speech recognition component 1604 in its processing of the input messages.

In a second part, a language understanding (LU) component 1606 optionally uses one or more analysis components (AC(s)) to interpret the user's utterance. Additional information regarding one implementation of the LU component 1606 is set forth below with respect to FIG. 17. The LU component 1606 outputs an interpreted user utterance.

In a third part, a dialog management component 1608 uses one or more analysis components (AC(s)) to track the state of the ongoing conversation and to map the interpreted user utterance into a PDA utterance. The PDA utterance represents the PDA component's response to the user's utterance. In one implementation, the dialog management component 1608 can use a machine-learned model (such as deep-learning neural network) to perform its mapping operation. Alternatively, or in addition, the dialog management component 1608 can use a rule application engine to perform its mapping operation. Alternatively, or in addition, the dialog management component 1608 can choose a PDA utterance based on one or more dialog script templates provided in a data store 1610. Alternatively, or in addition, the dialog management component 1608 can also consult other resources in formulating a PDA utterance, such as other applications 1612 (such as a calendar application), user history information 1614 maintained in a data store, etc.

In a fourth part, an response output component 1616 converts the PDA utterance generated by the dialog management component 1608 into an appropriate output form, and then sends the converted PDA utterance to user. For example, the response output component 1616 can use a text-to-speech synthesizer to convert a text-based indication of the PDA utterance into audio form.

FIG. 17 shows one implementation of the language understanding (LU) component 1606 of FIG. 16. The LU component 1606 includes at least one domain determination component 1702, at least one intent determination component 1704, and at least one slot value determination component 1706.

More specifically, the domain determination component 1702 determines the most probable domain associated with the input user utterance. A domain pertains to the general theme to which an input utterance pertains, which may correspond to a set of tasks handled by a particular application, or a subset of those tasks. For example, the command “find Mission Impossible” pertains to a media search domain.

The intent determination component 1704 determines an intent associated with the input user utterance. An intent corresponds to an objective that a user likely wishes to accomplish by submitting an input utterance. For example, a user who submits the command “find Mission Impossible” intends to find a particular movie having the name of “Mission Impossible.” A user who submits the command “buy Mission Impossible” intends to purchase the movie “Mission Impossible,” and so on.

The slot value determination component 1706 determines slot values in the input utterance. The slot values correspond to information items that an application needs to perform a requested task, upon interpretation of the input utterance. For example, the command, “find Jack Nicolson movies in the comedy genre” includes a slot value “Jack Nicolson” that identifies an actor having the name of “Jack Nicolson,” and a slot value “comedy,” corresponding to a requested genre of movies.

Any of the domain determination component 1702, intent determination component 1704, and slot value determination component 1706 can use any technology to perform their respective functions. For example, any of these components (1702, 1704, 1706) can use one or more machine-learned models. To cite merely one illustrative and non-limiting case, the domain determination component 1702 may correspond to a machine-learned classification model, such as a linear model, a deep-learning neural network model, a clustering-based model, a decision tree model, a support vector machine model, and so on. The intent determination component 1704 can likewise correspond to any of these kinds of models.

The slot value determination component 1706 may correspond to a machine-learned Conditional Random Fields (CRF) model. In this approach, a CRF model provides the most probable slot sequence defined by:

$$\hat{Y} = {arg max}_{Y} p ( Y \vert X ) .$$

In this equation, the term X refers to a sequence of tokens in a detected linguistic item (x₁, x₂, . . . , x_{T}) and Y refers to a sequence of tags (y₁, y₂, . . . , y_{T}) assigned to the tokens, where the tags are selected from a set C of possible tags. The tags correspond to slot variables, such as, in the media search domain, the tags, “actor name,” “release date,” “genre,” etc. In the above example, the CRF model would determine that the term “Jack Nicolson” corresponds to an actor name, having the particular value “Jack Nicolson.”

Alternatively, or in addition, any of the domain determination component 1702, the intent determination component 1704, and/or the slot value determination component 1706 can use a rule application engine to perform its respective analysis. For example, any of these components (1702, 1704, 1706) can apply rules which maps certain keywords in an input utterance into appropriate classification results. For instance, the intent determination component 1704 can apply a rule that indicates that any input utterance that matches the template “buy<x>” refers to an intent to buy a particular product, where that product is identified by the value of variable x.

D. Representative Computing Functionality

FIG. 18 shows computing functionality 1802 that can be used to implement any aspect of the mechanisms set forth in the above-described figures. For instance, the type of computing functionality 1802 shown in FIG. 18 can be used to implement any of the local user computing devices 204 of FIG. 2, and/or any server computing device of the computing systems (212, 228, 230) of FIG. 2. In all cases, the computing functionality 1802 represents one or more physical and tangible processing mechanisms.

The computing functionality 1802 can include one or more hardware processor devices 1804, such as one or more central processing units (CPUs), and/or one or more graphical processing units (GPUs), and so on. The computing functionality 1802 can also include any storage resources (also referred to as computer-readable storage media or computer-readable storage medium devices) 1806 for storing any kind of information, such as machine-readable instructions, settings, data, etc. Without limitation, for instance, the storage resources 1806 may include any of RAM of any type(s), ROM of any type(s), flash devices, hard disks, optical disks, and so on. More generally, any storage resource can use any technology for storing information. Further, any storage resource may provide volatile or non-volatile retention of information. Further, any storage resource may represent a fixed or removable component of the computing functionality 1802. The computing functionality 1802 may perform any of the functions described above when the hardware processor device(s) 1804 carry out computer-readable instructions stored in any storage resource or combination of storage resources. For instance, the computing functionality 1802 may carry out computer-readable instructions to perform each block of the processes described in Section B. The computing functionality 1802 also includes one or more drive mechanisms 1808 for interacting with any storage resource, such as a hard disk drive mechanism, an optical disk drive mechanism, and so on.

The computing functionality 1802 also includes an input/output component 1810 for receiving various inputs (via input devices 1812), and for providing various outputs (via output devices 1814). Illustrative input devices include a keyboard device, a mouse input device, a touchscreen input device, a digitizing pad, one or more video cameras, one or more depth cameras, one or more microphones, a voice recognition mechanism, any movement detection mechanisms (e.g., accelerometers, gyroscopes, etc.), and so on. One particular output mechanism may include a display device 1816 and an associated graphical user interface presentation (GUI) 1818. For instance, the local user computing device 206 can present a digital contact card on the display device 1816. The display device 1816 may correspond to a charge-coupled display device, a cathode ray tube device, a projection mechanism, etc. Other output devices include a printer, one or more speakers, a haptic output mechanism, an archival mechanism (for storing output information), and so on. The computing functionality 1802 can also include one or more network interfaces 1820 for exchanging data with other devices via one or more communication conduits 1822. One or more communication buses 1824 communicatively couple the above-described components together.

The communication conduit(s) 1822 can be implemented in any manner, e.g., by a local area computer network, a wide area computer network (e.g., the Internet), point-to-point connections, etc., or any combination thereof. The communication conduit(s) 1822 can include any combination of hardwired links, wireless links, routers, gateway functionality, name servers, etc., governed by any protocol or combination of protocols.

Alternatively, or in addition, any of the functions described in the preceding sections can be performed, at least in part, by one or more hardware logic components. For example, without limitation, the computing functionality 1802 (and its hardware processor) can be implemented using one or more of: Field-programmable Gate Arrays (FPGAs); Application-specific Integrated Circuits (ASICs); Application-specific Standard Products (ASSPs); System-on-a-chip systems (SOCs); Complex Programmable Logic Devices (CPLDs), etc. In this case, the machine-executable instructions are embodied in the hardware logic itself.

The following summary provides a non-exhaustive list of illustrative aspects of the technology set forth herein.

According to a first aspect, one or more computing devices are described for implementing a first personal digital assistant (PDA1) component for use by a first user. The device(s) include: logic configured to send a status inquiry message, over a computer network, to a registration system, upon a request by the first user to communicate with a second user; logic configured to receive, over the computer network, a status report message from the registration system, in response to the status inquiry message, the status report message conveying initial communication setup information; logic configured to determine a set of PDA1-specified communication options that can be used to communicate with the second user; logic configured to use the initial communication setup information to send a PDA1-to-PDA2 message, over the computer network, to a second personal digital assistant (PDA2) component associated with the second user, the PDA1-to-PDA2 message identifying the set of PDA1-specified communication options; logic configured to receive a PDA2-to-PDA1 message from the PDA2 component, over the computer network, the PDA2-to-PDA1 message providing at least one PDA2-suggested communication option, selected by the PDA2 component, for use in communicating with the second user, wherein the PDA2 component generates the PDA2-suggested communication option(s) based on consideration of a current context of the second user; and logic configured to present the PDA2-suggested communication option(s) to the first user. A user computing device associated with the first user carries out a communication with a user computing device associated with the second user, upon the first user invoking a PDA2-suggested communication option.

According to a second aspect, the device(s) further include logic configured to forward a status update message, over the computer network, to the registration system. The status update message conveys status update information, for storage by the registration system, the status update information describing a current status of the first user.

According to a third aspect, the initial setup communication information includes at least endpoint address information for use in contacting the PDA2 component.

According to a fourth aspect, the first user makes the request to communicate with the second user by activating a digital contact card associated with the second user.

According to a fifth aspect, the digital contact card includes a section that describes a set of default communication options by which the first user may communicate with the second user.

According to a sixth aspect, the logic configured to present is configured to provide the PDA2-suggested communication option(s) as part of the digital contact card.

According to a seventh aspect, the digital contact card includes: a first section that describes a set of default communication options by which the first user can communicate with the second user; and a second section that describes the PDA2-suggested communication option(s) provided by the PDA2 component.

According to an eighth aspect, a method is described that is implemented by one or more computing devices, for assisting a first user in communicating with a second user, the first user being associated with a first personal digital assistant component (PDA1) and the second user being associated with a second personal digital assistant component (PDA2). The method includes: forwarding a status update message, over a computer network, to a registration system, the status update message conveying status update information, for storage by the registration system, the status update information describing a current status of the second user; receiving a PDA1-to-PDA2 message, over the computer network, from the PDA1 component, the PDA1-to-PDA2 message identifying a set of PDA1-specified communication options, wherein the set of PDA1-specified communication options describes, from a perspective of the PDA1 component, viable modes for communicating with the second user; identifying context information that describes a current context of the second user; determining, based on the context information, at least one PDA2-suggested communication option for use by the first user in communicating with the second user; and sending a PDA2-to-PDA1 message, over the computer network, to the PDA1 component that conveys the PDA2-suggested communication option(s). The method performs communication between a user computing device associated with the first user and a user computing device associated with the second user, upon the first user invoking a PDA2-suggested communication option.

According to a ninth aspect, the PDA1-to-PDA2 message (referenced in the above method) is received in response to the PDA1 component accessing the registration system to determine initial communication setup information. Further, the PDA1 component uses the initial communication setup information to send the PDA1-to-PDA2 message to the PDA2 component.

According to a tenth aspect, the initial setup communication information (referenced in the ninth aspect) includes at least endpoint address information for use in contacting the PDA2 component.

According to an eleventh aspect, the context information describes: a current location of the second user; and/or at least one calendared commitment pertaining to the second user; and/or at least one communication resource that is currently available to the second user; and/or at least one communication preference of the second user.

According to a twelfth aspect, the above-referenced determining operation involves mapping the context information into the PDA2-suggested communication option(s) using one or more option-selection rules.

According to a thirteenth aspect, wherein the above-referenced determining operation involves mapping the context information into the PDA2-suggested communication option(s) using a machine-learned statistical model (as an alternative, or in addition to, the kind of mapping performed by the twelfth aspect).

According to a fourteenth aspect, a system is described for assisting a first user in communicating with a second user. The system includes: a first personal digital assistant (PDA1) component for providing a personal digital assistant service to a first user; a second personal digital assistant (PDA2) component for providing a personal digital assistant service to a second user; and a registration system configured to maintain a data store that provides status information regarding a current status of the first user and a current status of the second user. The registration system is configured to: receive a status update message from the PDA1 component or the PDA2 component over a computer network, the status update message conveying status update information that describes a current status of the first user or the second user, respectively; and store the status update information in a data store. The PDA1 component includes logic configured to: send a status inquiry message, over the computer network, to the registration system, upon a request by the first user to communicate with the second user; in a first case, receive, over the computer network, a status report message from the registration system, in response to the status inquiry message, the status report message conveying initial communication setup information; use the initial communication setup information to send a PDA1-to-PDA2 message, over the computer network, to the PDA2 component; and receive a PDA2-to-PDA1 message from the PDA2 component, over the computer network, the PDA2-to-PDA1 message providing at least one PDA2-suggested communication option, selected by the PDA2 component, for use in communicating with the second user. The PDA2 component includes logic configured to: receive the PDA1-to-PDA2 message, over the computer network, from the PDA1 component; identify context information that describes a current context of the second user; and determine, based on the context information, the PDA2-suggested communication option(s) for use by the first user in communicating with the second user. The system performs a communication between a user computing device associated with the first user and a user computing device associated with the second user, upon the first user invoking a PDA2-suggested communication option.

According to a fifteenth aspect, the registration system is further configured to: receive the status inquiry message from the PDA1 component, the status inquiry message conveying an intent by the first user to communicate with the second user; determine whether a status update message has been received from the PDA2 component within a specified interval of past time, with respect to a current time; in the first case, when the status update message has been received within the specified interval of past time, send the status report message to the PDA1 component; and in a second case, when the status update message has not been received within the specified interval of past time, send a message to the PDA1 component that conveys at least one registration-service-specified communication option to the first user.

According to a sixteenth aspect, with respect to the fourteenth aspect, the first user makes the request to communicate with the second user by activating a digital contact card associated with the second user.

According to a seventeenth aspect, the digital contact card (referenced in the sixteenth aspect) includes: a first section that describes a set of default communication options by which the first user can communicate with the second user; and a second section that describes the PDA2-suggested communication option(s) provided by the PDA2 component.

According to an eightieth aspect, the context information (referenced in the fourteenth aspect) describes: a current location of the second user; and/or at least one calendared commitment pertaining to the second user; and/or at least one communication resource that is currently available to the second user; and/or at least one communication preference of the second user.

According to a nineteenth aspect, the request from the first user indicates an intent to communicate with both a second user and a third user, the third user being associated with a third personal digital assistant (PDA3) component. Further, the PDA1 component is configured to interact with the PDA3 component to cause the PDA3 component to generate at least one PDA3-suggested communication option for use by the first user in communicating with the third user.

According to a twentieth aspect, the system further includes a compilation component configured to prepare and present a final set of suggested communication options based on the PDA2-suggested communication option(s) provided by the PDA2 component and the PDA3-suggested communication option(s) received from the PDA3 component.

A twenty-first aspect corresponds to any combination (e.g., any permutation or subset that is not logically inconsistent) of the above-referenced first through twentieth aspects.

A twenty-second aspect corresponds to any method counterpart, device counterpart, system counterpart, means-plus-function counterpart, computer-readable storage medium counterpart, data structure counterpart, article of manufacture counterpart, graphical user interface presentation counterpart, etc. associated with the first through twenty-first aspects.

In closing, the functionality described herein can employ various mechanisms to ensure that any user data is handled in a manner that conforms to applicable laws, social norms, and the expectations and preferences of individual users. For example, the functionality can allow a user to expressly opt in to (and then expressly opt out of) the provisions of the functionality. The functionality can also provide suitable security mechanisms to ensure the privacy of the user data (such as data-sanitizing mechanisms, encryption mechanisms, password-protection mechanisms, etc.).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more computing devices for implementing a first personal digital assistant (PDA1) component for use by a first user, comprising:
logic configured to send a status inquiry message, over a computer network, to a registration system, upon a request by the first user to communicate with a second user;
logic configured to receive, over the computer network, a status report message from the registration system, in response to the status inquiry message, the status report message conveying initial communication setup information;
logic configured to determine a set of PDA1-specified communication options that can be used to communicate with the second user;
logic configured to use the initial communication setup information to send a PDA1-to-PDA2 message, over the computer network, to a second personal digital assistant (PDA2) component associated with the second user, the PDA1-to-PDA2 message identifying the set of PDA1-specified communication options;
logic configured to receive a PDA2-to-PDA1 message from the PDA2 component, over the computer network, the PDA2-to-PDA1 message providing at least one PDA2-suggested communication option, selected by the PDA2 component, for use in communicating with the second user,
the PDA2 component generating said at least one PDA2-suggested communication option based on consideration of a current context of the second user; and
logic configured to present said at least one PDA2-suggested communication option to the first user,
a user computing device associated with the first user carrying out a communication with a user computing device associated with the second user, upon the first user invoking a PDA2-suggested communication option.

2. The one or more computing devices of claim 1,
further comprising logic configured to forward a status update message, over the computer network, to the registration system,
the status update message conveying status update information, for storage by the registration system, the status update information describing a current status of the first user.

3. The one or more computing devices of claim 1, wherein the initial setup communication information includes at least endpoint address information for use in contacting the PDA2 component.

4. The one or more computing devices of claim 1, wherein the first user makes the request to communicate with the second user by activating a digital contact card associated with the second user.

5. The one or more computing devices of claim 4, wherein the digital contact card includes a section that describes a set of default communication options by which the first user may communicate with the second user.

6. The one or more computing devices of claim 4, wherein said logic configured to present is configured to provide said at least one PDA2-suggested communication option as part of the digital contact card.

7. The one or more computing devices of claim 4, wherein the digital contact card includes:
a first section that describes a set of default communication options by which the first user can communicate with the second user; and
a second section that describes said at least one PDA2-suggested communication option provided by the PDA2 component.

8. A method, implemented by one or more computing devices, for assisting a first user in communicating with a second user, the first user being associated with a first personal digital assistant component (PDA1) and the second user being associated with a second personal digital assistant component (PDA2), the method comprising:
forwarding a status update message, over a computer network, to a registration system, the status update message conveying status update information, for storage by the registration system, the status update information describing a current status of the second user;
receiving a PDA1-to-PDA2 message, over the computer network, from the PDA1 component, the PDA1-to-PDA2 message identifying a set of PDA1-specified communication options,
the set of PDA1-specified communication options describing, from a perspective of the PDA1 component, viable modes for communicating with the second user;
identifying context information that describes a current context of the second user;
determining, based on the context information, at least one PDA2-suggested communication option for use by the first user in communicating with the second user; and
sending a PDA2-to-PDA1 message, over the computer network, to the PDA1 component that conveys said at least one PDA2-suggested communication option,
the method performing communication between a user computing device associated with the first user and a user computing device associated with the second user, upon the first user invoking a PDA2-suggested communication option.

9. The method of claim 8,
wherein the PDA1-to-PDA2 message is received in response to the PDA1 component accessing the registration system to determine initial communication setup information, and
wherein the PDA1 component uses the initial communication setup information to send the PDA1-to-PDA2 message to the PDA2 component.

10. The method of claim 9, wherein the initial setup communication information includes at least endpoint address information for use in contacting the PDA2 component.

11. The method of claim 8, wherein the context information describes:
a current location of the second user; and/or
at least one calendared commitment pertaining to the second user; and/or
at least one communication resource that is currently available to the second user; and/or
at least one communication preference of the second user.

12. The method of claim 8, wherein said determining involves mapping the context information into said at least one PDA2-suggested communication option using one or more option-selection rules.

13. The method of claim 8, wherein said determining involves mapping the context information into said at least one PDA2-suggested communication option using a machine-learned statistical model.

14. A system for assisting a first user in communicating with a second user, comprising:
a first personal digital assistant (PDA1) component for providing a personal digital assistant service to a first user;
a second personal digital assistant (PDA2) component for providing a personal digital assistant service to a second user;
a registration system configured to maintain a data store that provides status information regarding a current status of the first user and a current status of the second user;
the registration system being configured to:
receive a status update message from the PDA1 component or the PDA2 component over a computer network,
the status update message conveying status update information that describes a current status of the first user or the second user, respectively; and
store the status update information in a data store;
the PDA1 component including logic configured to:
send a status inquiry message, over the computer network, to the registration system, upon a request by the first user to communicate with the second user;
in a first case, receive, over the computer network, a status report message from the registration system, in response to the status inquiry message, the status report message conveying initial communication setup information;
use the initial communication setup information to send a PDA1-to-PDA2 message, over the computer network, to the PDA2 component; and
receive a PDA2-to-PDA1 message from the PDA2 component, over the computer network, the PDA2-to-PDA1 message providing at least one PDA2-suggested communication option, selected by the PDA2 component, for use in communicating with the second user; and
the PDA2 component including logic configured to:
receive the PDA1-to-PDA2 message, over the computer network, from the PDA1 component;
identify context information that describes a current context of the second user; and
determine, based on the context information, said at least one PDA2-suggested communication option for use by the first user in communicating with the second user,
the system performing a communication between a user computing device associated with the first user and a user computing device associated with the second user, upon the first user invoking a PDA2-suggested communication option.

15. The system of claim 14, wherein the registration system is further configured to:
receive the status inquiry message from the PDA1 component, the status inquiry message conveying an intent by the first user to communicate with the second user;
determine whether a status update message has been received from the PDA2 component within a specified interval of past time, with respect to a current time;
in the first case, when the status update message has been received within the specified interval of past time, send the status report message to the PDA1 component; and
in a second case, when the status update message has not been received within the specified interval of past time, send a message to the PDA1 component that conveys at least one registration-service-specified communication option to the first user.

16. The system of claim 14, wherein the first user makes the request to communicate with the second user by activating a digital contact card associated with the second user.

17. The system of claim 16, wherein the digital contact card includes:
a first section that describes a set of default communication options by which the first user can communicate with the second user; and
a second section that describes said at least one PDA2-suggested communication option provided by the PDA2 component.

18. The system of claim 14, wherein the context information describes:
a current location of the second user; and/or
at least one calendared commitment pertaining to the second user; and/or
at least one communication resource that is currently available to the second user; and/or
at least one communication preference of the second user.

19. The system of claim 14,
wherein the request from the first user indicates an intent to communicate with both a second user and a third user, the third user being associated with a third personal digital assistant (PDA3) component, and
wherein the PDA1 component is configured to interact with the PDA3 component to cause the PDA3 component to generate at least one PDA3-suggested communication option for use by the first user in communicating with the third user.

20. The system of claim 19, wherein the system further includes a compilation component configured to prepare and present a final set of suggested communication options based on said at least one PDA2-suggested communication option provided by the PDA2 component and said at least one PDA3-suggested communication option received from the PDA3 component.
